(19) United States
(12) Patent Application Publication
(10) Pub. No.: US 2013/0263989 A1
(43) Pub. Date: Oct. 10, 2013

(54) TYRE COMPRISING A SELF-SEALING LAYER HAVING AN AXIAL CREEP GRADIENT

(71) Applicants: Bozena Voge, Clermont-Ferrand Cedex 9 (FR); José Merino Lopez, Clermont-Ferrand Cedex 9 (FR); Michel Ahouanto, Clermont-Ferrand Cedex 9 (FR)

(72) Inventors: Bozena Voge, Clermont-Ferrand Cedex 9 (FR); José Merino Lopez, Clermont-Ferrand Cedex 9 (FR); Michel Ahouanto, Clermont-Ferrand Cedex 9 (FR)

(73) Assignees: MICHELIN RECHERCHE ET TECHNIQUE S.A., GRANGES-PACCOT (CH); COMPAGNIE GENERALE DES ETABLISSEMENTS MICHELIN, CLERMONT-FERRAND (FR)

(21) Appl. No.: 13/879,202

(22) PCT Filed: Oct. 13, 2011
(86) PCT No.: PCT/FR2011/052388

§ 371 Date: Jun. 24, 2013

(30) Foreign Application Priority Data
Oct. 18, 2010 (FR) 1058487

(51) Int. Cl. B60C 19/12

(52) U.S. Cl. CPC B60C 19/12
USPC 152/502; 156/123

(57) ABSTRACT

A pneumatic tyre includes an internal sealing layer, which partially delimits an internal volume (V) of the pneumatic tyre, and a self-sealing layer formed of at least a self-sealing product. The self-sealing layer is positioned radially on an inside region with respect to the internal sealing layer, and has a creep resistance indicator that increases axially from a median plane outwards, i.e., towards outside of the pneumatic tyre.

The invention relates to the field of pneumatic tyres and, more particularly, to the field of pneumatic tyres equipped with means for self-sealing a puncture in the pneumatic tyre.

In general, a pneumatic tyre comprises an internal sealing layer delimiting the internal volume of the pneumatic tyre. This layer generally comprises a rubber of the butyl type which is known for its airtightness.

In use, the pneumatic tyre may become punctured if a perforating object, for example a nail, perforates the pneumatic tyre. Such perforation causes the pneumatic tyre to lose air.

In order to prevent the pneumatic tyre from losing air, it has been proposed that an additional layer of a relatively soft product capable of creeping readily be positioned in contact with the internal sealing layer. Thus, in the event of a puncture, the product of the additional layer, because of its softness and its ability to creep readily, penetrates the puncture and prevents the pneumatic tyre from losing air. Such a product with relative softness and the ability to creep readily is said to be self-sealing.

However, developing a self-sealing product is a relatively complex process. Specifically, if the product is too soft and/or has too great an ability to creep, the self-sealing product may creep under the effect of centrifugal force when the pneumatic tyre is being used. Thus, the product creeps axially towards the centre of the pneumatic tyre. The axially external parts, or shoulders, of the pneumatic tyre are then not as well protected. Furthermore, the product may creep axially towards the centre of the pneumatic tyre even when the pneumatic tyre is stationary, particularly under conditions of high temperature. In addition, if the puncturing object is removed from the pneumatic tyre, the self-sealing product may creep out through the puncture and escape from the pneumatic tyre. The function of preventing air loss is then no longer assured.

Furthermore, if the product is too rigid and/or does not have a great enough ability to creep, the product does not creep into the puncture sufficiently, particularly in cold weather.

It is therefore an object of the invention to provide a layer of self-sealing product that is more effective.

To that end, one subject of the invention is a pneumatic tyre comprising an internal sealing layer partially delimiting the internal volume of the pneumatic tyre, the pneumatic tyre comprising a layer of at least one self-sealing product, known as the self-sealing layer, positioned radially on the inside with respect to the internal sealing layer, the self-sealing layer having a creep resistance indicator that increases axially from the median plane towards the outside of the pneumatic tyre.

The layer effectively performs the self-sealing function in a manner which is durable in service. Specifically, the part that creeps the most is positioned in the central part of the pneumatic tyre where the risks of creep are the least. The axially external parts or shoulders of the pneumatic tyre are protected by the part that does not creep as much but which does however adequately prevent a loss of air.

The axial increase in an indicator corresponds to an increase in the indicator in a direction axially through the layer of self-sealing product from the median plane of the pneumatic tyre towards the outside of the pneumatic tyre. Thus, an increase may be continuous, i.e., the indicator decreases then increases constantly in a direction axially from one shoulder to the other through the layer of self-sealing product. An increase may also be discontinuous, which means that the indicator varies in stages when progressing axially through the layer of self-sealing product.

The creep resistance indicator is indicative of the ability of the product to withstand deformation under the effect of a stress over a certain period of time. The lower the indicator, the more the product can creep; the higher the indicator, the less the product can creep.

In the present description, unless expressly indicated otherwise, all percentages (%) are mass %. Further, any range of values denoted by the expression “between a and b” represents the range of values extending from more than a to less than b (i.e., a and b end points excluded), whereas any range of values denoted by the expression “from a to b” means the range of values from end point “a” to end point “b”, i.e., including the strict end points “a” and “b”.

In the elastomeric compositions of the present description, the abbreviation “phr” means part by weight per hundred parts of solid elastomer.

Advantageously, the self-sealing product is an elastomeric composition containing at least, by way of predominant elastomer (preferably representing over 50 phr), one diene elastomer, a hydrocarbon resin, a liquid plasticizer the glass transition temperature of which is below −10° C., preferably −20° C., or even −30° C., and possibly a filler.

For preference, the self-sealing product comprises:
between 20 and 90 phr of the hydrocarbon resin;
at most 60 phr of the liquid plasticizer;
at most 60 phr of fillers.

For preference, the liquid plasticizer content in the self-sealing layer is at a maximum in an axially central portion of the self-sealing layer and at a minimum in an axial end portion of the self-sealing layer. In other words, the self-sealing layer has a liquid plasticizer content that decreases axially towards the outside of the pneumatic tyre.

The difference in content is preferably greater than 5 phr.

For preference, the fillers content in the self-sealing layer is at a minimum in an axially central portion of the self-sealing layer and at a maximum in an axial end portion of the self-sealing layer. In other words, the self-sealing layer has a fillers content that increases axially towards the outside of the pneumatic tyre.

According to another, alternative or complementary, embodiment, with the self-sealing product further comprising a cross linking system, the cross linking-system content in the self-sealing layer is at a minimum in an axially central portion of the self-sealing layer and at a maximum in an axial end portion of the self-sealing layer. In other words, the self-sealing layer has a cross linking system content that increases axially towards the outside of the pneumatic tyre.

According to one preferred embodiment, the self-sealing layer comprises first and second layers respectively of first and second distinct self-sealing products, in which the first layer of first self-sealing product is positioned axially on both sides of the second layer of second self-sealing product positioned in an axially central portion of the pneumatic tyre and in which the first self-sealing product has a creep resistance indicator greater than a creep resistance indicator of the second self-sealing product.

According to other features of the invention of the pneumatic tyre according to the invention:
The first and second layers are positioned in contact with the internal sealing layer.
The first layer is placed at the shoulders and may extend as far as the sidewalls of the pneumatic tyre.

Advantageously, each of the first and second self-sealing products contains, by way of predominant elastomer, a diene elastomer, a hydrocarbon resin, a liquid plasticizer the glass transition temperature of which is below −10° C., preferably −20° C., or even −30° C., and possibly a filler.

For preference, the first self-sealing product comprises:
between 20 and 70 phr of a hydrocarbon resin;
at most 20 phr of a liquid plasticizer, preferably at most 2 phr of the liquid plasticizer;
at most 60 phr of fillers.

For preference, the second self-sealing product comprises:
between 30 and 90 phr of a hydrocarbon resin;
at most 60 phr of a liquid plasticizer;
at most 30 phr of fillers.

The creep resistance indicator may be a Mooney viscosity measurement effected at 60° C. using an L-type rotor.

For preference, the amplitude by which the creep resistance indicator in the self-sealing layer varies is between 3 and 25 Mooney units (UM) and highly preferably, between 5 and 20 Mooney units (UM).

Below 3 UM, the increase in creep resistance of the self-sealing layer positioned in the shoulders is not enough to guarantee sufficient creep resistance and beyond 25 UM, it is the air loss prevention function that is no longer assured.

According to other optional features of the pneumatic tyre according to the invention:
The fillers content of the first self-sealing product is greater than the fillers content of the second sealing product;
The liquid plasticizer content of the first self-sealing product is less than the liquid plasticizer content of the second self-sealing product;
The products further comprise a system for cross linking the diene elastomer, and the cross linking system content of the first self-sealing product is greater than the cross linking system content of the second self-sealing product.

The characteristics relating to the contents of fillers, liquid plasticizer and cross linking system in the first and second self-sealing products mean, individually or synergistically, that the first self-sealing product is rendered more creep resistant, i.e., less able to creep than the second self-sealing product but it also allows the level of tack of the first self-sealing product to be reduced in relating to the level of tack of the second self-sealing product.

The diene elastomer is of saturated or unsaturated type. What is meant by an unsaturated diene elastomer is a diene elastomer derived at least in part from conjugated diene monomers having a content of units derived from conjugated dienes which is higher than 30% (mol %), preferably 50%. Such a diene elastomer is preferably selected from the group consisting of polybutadiene (BR), natural rubber (NR) synthetic polyisoprenes (IR), butadiene copolymers, isoprene copolymers and mixtures of such elastomers. The unsaturated diene elastomer is more advantageously an isoprene elastomer, preferably selected from the group consisting of natural rubber, synthetic polyisoprenes and mixtures of such elastomers.

The term “resin” is reserved in this application, by the definition known to those skilled in the art, for a compound which is solid at room temperatures (23° C.), as opposed to a liquid plasticizing compound such as an oil.

The hydrocarbon resin is selected from the group consisting of homopolymer or copolymer cyclopentadiene (CPD) or dicyclopentadiene (DCPD) resins, homopolymer or copolymer terpene resins, homopolymer or copolymer cut C5 resins, and mixtures of such resins. Of the copolymer resins stated hereinabove, the hydrocarbon resin is advantageously selected from the group consisting of CPD/vinylaromatic copolymer resins, DCPD/vinylaromatic copolymer resins, CPD/terpene copolymer resins, DCPD/terpene copolymer resins, CPD/C5 cut copolymer resins, DCPD/C5 cut copolymer resins, terpene/vinylaromatic copolymer resins, C5 cut/vinylaromatic copolymer resins and mixtures of these resins.

The liquid (at 23° C.) plasticizing agent said to be of low Tg (glass transition temperature) has the role of softening the self-sealing product by diluting the diene elastomer and the hydrocarbon resin, in particularly improving the cold self-sealing performance.

The plasticizing agent is selected from the group consisting of liquid elastomers, polyolefin oils, naphthene oils, paraffin oils, DAE (Distillate Aromatic Extracts) oils, MES (Medium Extracted Extracts) oils, TDAE (Treated Distillate Aromatic Extracts) oils, mineral oils, vegetable oils, ether plasticizers, phosphate plasticizers, sulfonate plasticizers and mixtures of these compounds. For preference, the liquid plasticizer is selected from the group consisting of liquid elastomers, polyolefin oils, vegetable oils and mixtures of these compounds. Highly preferably, the liquid plasticizer is selected from the group consisting of liquid polybutadienes, liquid polyisoprenes, vegetable oils and mixtures of these compounds.

The fillers are of the reinforcing, non-reinforcing or inert type and have the role of providing the self-sealing product with a minimal mechanical integrity. The fillers are, for example, nanoparticles of carbon black or reinforcing inorganic fillers or a mixture of these two types of filler. The non-reinforcing fillers may be microparticles of natural calcium carbonates (chalk) or synthetic calcium carbonates, synthetic or natural silicates (such as kaolin, talc, mica), ground silicas, titanium oxides, aluminas or even aluminosilicates.

Various additives may also be added, preferably in a quantity less than 20 phr, more preferably than 15 phr. The additives contain protective agents such as anti-UV, antioxidants or antiozone agents, various other stabilizers, colorants which may advantageously be used for colouring each self-sealing product.

Each self-sealing product may also optionally comprise a system for cross linking the diene elastomer. This system is of the vulcanizing type, in this instance based on sulphur.

Another subject of the invention is a method of manufacturing a green pneumatic tyre, in which:
at least one layer of at least one self-sealing product, known as the self-sealing layer, is applied to a surface of a tyre-building drum, the self-sealing layer having a creep resistance indicator that increases axially from the median plane towards the outside of the pneumatic tyre,
an internal sealing layer is applied in contact with the self-sealing layer.

The invention will be better understood upon reading the description which will follow, which is given solely by way of nonlimiting example and with reference to the drawings in which:

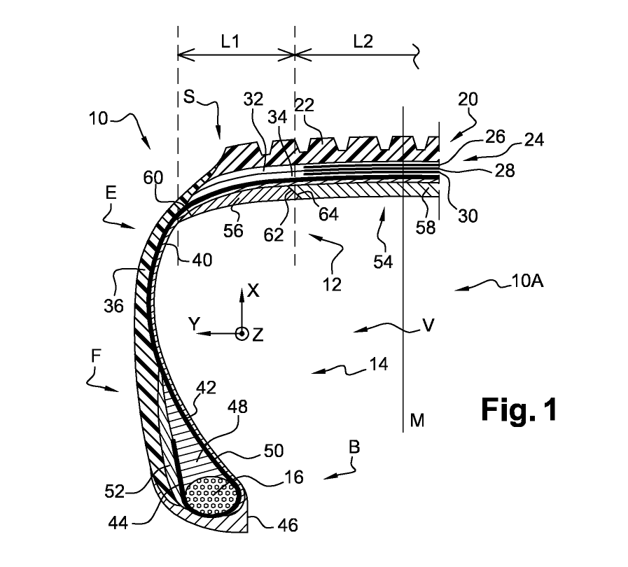

FIG. 1 illustrates a view in radial section of a pneumatic tyre according to one embodiment of the invention;

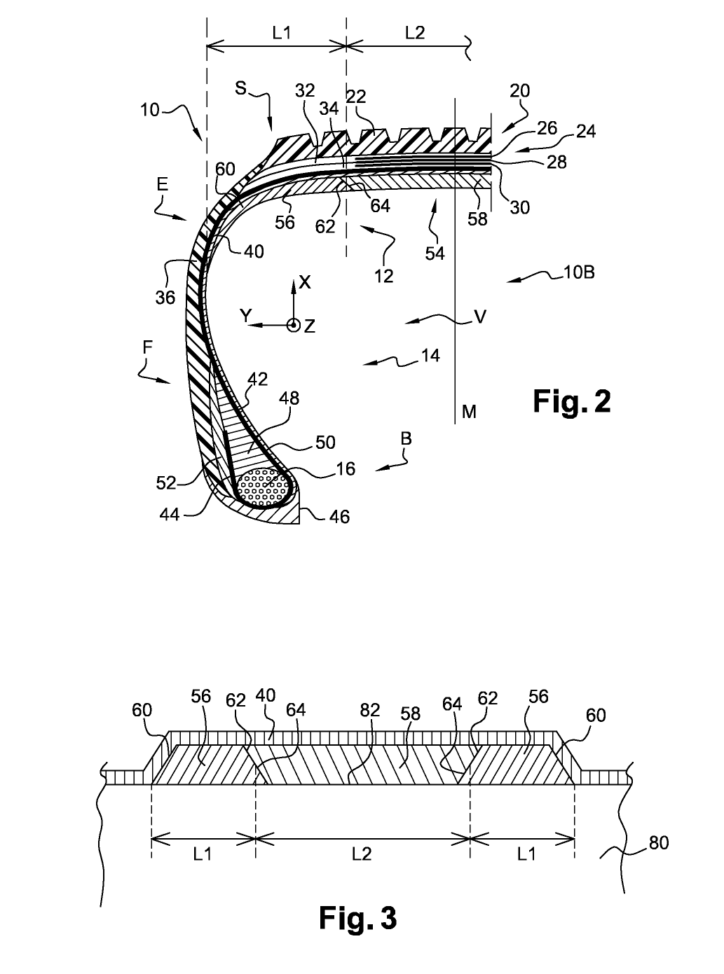

FIG. 2 illustrates a view in radial section of a pneumatic tyre according to a second embodiment of the invention; and

FIG. 3 presents a partial view in radial section of a green pneumatic tyre in accordance with one embodiment of the invention.

Mutually orthogonal axes X, Y, Z corresponding to the habitual radial (X), axial (Y) and circumferential (Z) orientations of the pneumatic tyre have been indicated in the figures.

FIG. 1 depicts a pneumatic tyre according to one embodiment of the invention, denoted by the overall reference 10A.

In this particular instance, the pneumatic tyre 10A is intended to be fitted to

a wheel of a motor vehicle of the passenger vehicle type.

In the conventional way, the pneumatic tyre 10A comprises a crown S extended by two shoulders E, two sidewalls F and two beads B. Just one sidewall F, just one shoulder E and just one bead B are depicted in the figures.

Two bead wires 16 (just one is depicted) are embedded in the beads B. The two bead wires 16 are arranged symmetrically with respect to a median radial plane M of the pneumatic tyre.

Each bead wire 16 is of revolution about a reference axis. This reference axis, substantially parallel to the direction Y, more or less coincides with an axis of revolution of the pneumatic tyre.

The crown S comprises a tread 20, equipped with tread patterns 22, and a reinforcement 24. This reinforcement 24 comprises plies of metal or textile reinforcers 26, 28 and 30 embedded in masses of rubber 32 and 34.

A mass of rubber 36 extends radially from the crown as far as the bead wire 16 of the bead B, thereby delimiting an outer surface 38 of the shoulder E, of the sidewall F and of the bead B.

The pneumatic tyre 10A also comprises an inner liner layer of sealing rubber 40, and a carcass ply 42. The layer 40 at least partially delimits the internal volume V of the pneumatic tyre 10A and is made of a rubber of butyl type. The layer 40 and the ply 42 are of toroidal overall shape and are both coaxial with the bead wires 16. The layer 40 and the ply 42 extend between the two annular bead wires 16 of the pneumatic tyre 10A, passing via the crown S.

In the bead B of the pneumatic tyre 10A, the carcass ply 42 comprises a part 44 turned back around the bead wire 16. The bead B also comprises an annular mass of protective rubber 46 intended, in part, to allow the pneumatic tyre 10A to be secured radially and axially to a rim.

The bead B of the pneumatic tyre 10A also comprises a mass of rubber 48 for filling a volume comprised between the turned-back part 44 of the carcass ply 42 and a part 50 of the carcass ply 42 that axially faces the turned-back part 44. The bead B also comprises a mass of rubber 52. This mass 52 forms a filling mass which at least partially covers the turned-back part 44 of the carcass ply 42. The mass 52 is locally separated from the mass 48 by the turned-back part 44.

The pneumatic tyre 10A also comprises a layer 54 of at least one self-sealing product arranged radially internally with respect to the layer of sealing rubber 40. In this particular instance, the layer 54 is applied in contact with the internal sealing layer 40. The layer 54 at least partially delimits the internal volume V of the pneumatic tyre.

The layer 54 comprises a first layer 56 of a first self-sealing product O1 positioned on the axial end portions L1 at the shoulders of the pneumatic tyre 10A. The layer 54 also comprises a second layer 58 of a second self-sealing product O2 distinct from the first product O1. The second layer 58 is positioned axially between the two parts of the first layer 56 in an axially central portion L2 of the pneumatic tyre 10A. The two layers 56 and 58 are in contact with the sealing layer 40.

Each of the first and second self-sealing products O1, O2 comprises, by way of predominant elastomer, a saturated diene elastomer, a hydrocarbon resin, a liquid plasticizer the glass transition temperature of which is below −10° C. and possibly a filler and a cross linking system.

The first self-sealing product O1 comprises between 20 and 70 phr of the hydrocarbon resin, at most 20 phr of the liquid plasticizer and at most 60 phr of the fillers. In this particular instance, the first self-sealing product O1 advantageously comprises at most 2 phr of the liquid plasticizer. For preference, the diene elastomer is saturated.

The second self-sealing product O2 comprises between 30 and 90 phr of the hydrocarbon resin, at most 60 phr of the liquid plasticiser and at most 30 phr of the fillers. For preference, the diene elastomer is unsaturated.

The fillers content of the self-sealing layer 54 is at a minimum in the axially central portion L2 of the self-sealing layer 54 and at a maximum in the axial end inner portion L1 of the self-sealing layer 54. Here, the fillers content of the first self-sealing product O1 is greater than or equal to the fillers content of the second self-sealing product O2, which means that the self-sealing layer 54 has a fillers content that increases axially towards the outside of the pneumatic tyre.

The liquid plasticizer content in the self-sealing layer 54 is at a maximum in the axially central portion L2 of the self-sealing layer 54 and at a minimum in the axial end portion L1 of the self-sealing layer 54. Here, the liquid plasticizer content of the first self-sealing product O1 is less than the liquid plasticizer content of the second self-sealing product O2, which means that the self-sealing layer 54 has a liquid plasticizer content that decreases axially towards the outside of the pneumatic tyre.

The cross linking system content of the self-sealing layer 54 is at a minimum in the axially central portion L2 of the self-sealing layer 54 and at a maximum in the axial end portion L1 of the self-sealing layer 54. Here, the cross linking system

content of the first self-sealing product O1 is greater than or equal to the cross linking system content of the second self-sealing product O2, which means that the self-sealing layer 54 has a cross linking system content that increases axially towards the outside of the pneumatic tyre.

The first and second layers 56, 58 directly cover the internal sealing layer 40 and partially delimit the internal volume of the pneumatic tyre 10A. The first layer 56 comprises two end edges, axially outer 60 and axially inner 62. The second layer 58 also comprises two end edges 64. In this particular instance, each edge 60 is inclined axially towards the outside of the pneumatic tyre in a direction radially towards the inside of the pneumatic tyre. The edges 62 and the edges 64 are inclined axially towards the inside of the pneumatic tyre in a direction radially towards the inside of the pneumatic tyre. In this way, the layer 58 is blocked and held against the internal sealing layer 40 by the layer 56.

The layer 54 has a creep resistance indicator I that increases axially away from the median plane M of the pneumatic tyre. The first layer 56 has a creep resistance indicator I1 higher than a creep resistance indicator I2 of the second layer 58. In this particular instance, each creep resistance indicator I, I1, I2 is a Mooney measurement value effected using a type L rotor at 60° C. A Mooney measurement has the units Mooney units for which a symbol is UM. Mooney measurements are effected using a viscosimeter in accordance with standard ASTM D 1646-99. Mooney measurements are carried out according to the following principle: the generally raw mixture is moulded in a cylindrical chamber heated to a given temperatures, usually 100° C. and in this instance 60° C. After one minute of preheating, the rotor is rotated in the test specimen at 2 revolutions per minute and the torque needed to sustain this motion after 4 minutes of rotation is measured.

For preference, the variation in the creep resistance indicator is comprised between 3 and 25 UM and, more preferably still, between 5 and 20 UM.

It should be noted that the self-sealing products described have a very low level of cross linking after the pneumatic tyre has been vulcanized such that it is still possible to characterized these products in terms of their UM.

One method of building a green form of the pneumatic tyre 10A will now be described with the aid of FIG. 3.

Use is made of a tyre-building drum 80 which is substantially of revolution about an axis coincident with the axis of the green tyre which is also the axis of the future pneumatic tyre 10A. The drum 80 comprises an external surface 82 on which the various layers of products are laid.

The first layer 56 and second layer 58 are laid successively or conjointly on the laying surface 82 of the tyre-building drum. For preference, the first layer 56 is laid first, then the second layer 58. Next, the internal sealing layer 40 is laid in contact with the layers 56 and 58. Finally, the subsequent layers and plies are laid in order to create a green tyre that will be used to obtain the pneumatic tyre 10A of FIG. 1.

In a variant which is not illustrated, prior to laying the first layer 56 and second layer 58 on the surface 82, a thermoplastic film is laid on the external surface 82.

FIG. 2 depicts a pneumatic tyre 10B according to a second embodiment of the invention. Elements similar to those depicted in the preceding figure are denoted via identical references.

In contrast with the first embodiment, the first layer 56 is in contact with the layer 40 along the shoulder E and a portion of the sidewall F. This embodiment has the advantage of protecting the pneumatic tyre 10B against air loss from the shoulders E and the adjacent parts of the sidewalls F.

The invention is not restricted to the embodiments described hereinabove.

Specifically, the number of layers of distinct self-sealing products can be increased in order to make the variation in creep resistance of the self-sealing layer more progressive.

1-12. (canceled)

13. A pneumatic tyre comprising:
an internal sealing layer structured to partially delimit an internal volume of the pneumatic tyre; and
a self-sealing layer formed of at least a self-sealing product, the self-sealing layer being positioned radially on an inside region with respect to the internal sealing layer, and the self-sealing layer having a creep resistance indicator that increases axially from a median plane towards outside of the pneumatic tyre.

14. The pneumatic tyre according to claim 13, wherein the self-sealing product includes:
a diene elastomer serving as a predominant elastomer,
between 20 and 90 parts by weight per hundred parts of solid elastomer of a hydrocarbon resin,
at most 60 parts by weight per hundred parts of solid elastomer of a liquid plasticizer, the liquid plasticizer having a glass transition temperature below −10° C., and
at most 60 parts by weight per hundred parts of solid elastomer of a filler.

15. The pneumatic tyre according to claim 14, wherein a content of the liquid plasticizer in the self-sealing layer is at a maximum in an axially central portion of the self-sealing layer and at a minimum in an axial end portion of the self-sealing layer.

16. The pneumatic tyre according to claim 15, wherein an axial variation in the content of the liquid plasticizer in the self-sealing layer is greater than 5 parts per hundred parts of solid elastomer.

17. The pneumatic tyre according to claim 14, wherein a content of the filler in the self-sealing layer is at a minimum in an axially central portion of the self-sealing layer and at a maximum in an axial end portion of the self-sealing layer.

18. The pneumatic tyre according to claim 15, wherein a content of the filler in the self-sealing layer is at a minimum in an axially central portion of the self-sealing layer and at a maximum in an axial end portion of the self-sealing layer.

19. The pneumatic tyre according to claim 16, wherein a content of the filler in the self-sealing layer is at a minimum in an axially central portion of the self-sealing layer and at a maximum in an axial end portion of the self-sealing layer.

20. The pneumatic tyre according to claim 13,
wherein the self-sealing product includes a cross linking system, and
wherein a content of the cross linking system is at a minimum in an axially central portion of the self-sealing layer and at a maximum in an axial end portion of the self-sealing layer.

21. The pneumatic tyre according to claim 14,
wherein the self-sealing product includes a cross linking system, and
wherein a content of the cross linking system is at a minimum in an axially central portion of the self-sealing layer and at a maximum in an axial end portion of the self-sealing layer.

22. The pneumatic tyre according to claim 15,
wherein the self-sealing product includes a cross linking system, and
wherein a content of the cross linking system is at a minimum in an axially central portion of the self-sealing layer and at a maximum in an axial end portion of the self-sealing layer.

23. The pneumatic tyre according to claim 16,
wherein the self-sealing product includes a cross linking system, and
wherein a content of the cross linking system is at a minimum in an axially central portion of the self-sealing layer and at a maximum in an axial end portion of the self-sealing layer.

24. The pneumatic tyre according to claim 13,
wherein the self-sealing layer includes first and second layers formed respectively of first and second self-sealing products,
wherein the first layer formed of the first self-sealing product is positioned axially on first and second sides of the second layer formed of the second self-sealing product, which is positioned in an axially central portion of the pneumatic tyre, and
wherein the first self-sealing product has a creep resistance indicator greater than a creep resistance indicator of the second self-sealing product.

25. The pneumatic tyre according to claim 14,
wherein the self-sealing layer includes first and second layers formed respectively of first and second self-sealing products,
wherein the first layer formed of the first self-sealing product is positioned axially on first and second sides of the second layer formed of the second self-sealing product, which is positioned in an axially central portion of the pneumatic tyre, and
wherein the first self-sealing product has a creep resistance indicator greater than a creep resistance indicator of the second self-sealing product.

26. The pneumatic tyre according to claim 15,
wherein the self-sealing layer includes first and second layers formed respectively of first and second self-sealing products,
wherein the first layer formed of the first self-sealing product is positioned axially on first and second sides of the second layer formed of the second self-sealing product, which is positioned in an axially central portion of the pneumatic tyre, and
wherein the first self-sealing product has a creep resistance indicator greater than a creep resistance indicator of the second self-sealing product.

27. The pneumatic tyre according to claim 16,
wherein the self-sealing layer includes first and second layers formed respectively of first and second self-sealing products,
wherein the first layer formed of the first self-sealing product is positioned axially on first and second sides of the second layer formed of the second self-sealing product, which is positioned in an axially central portion of the pneumatic tyre, and
wherein the first self-sealing product has a creep resistance indicator greater than a creep resistance indicator of the second self-sealing product.

28. The pneumatic tyre according to claim 24, wherein the first self-sealing product includes:
between 20 and 70 parts by weight of a hydrocarbon resin per hundred parts of solid elastomer,
at most 20 parts by weight of a liquid plasticizer per hundred parts of solid elastomer, and
at most 60 parts by weight of a filler material per hundred parts of solid elastomer.

29. The pneumatic tyre according to claim 25, wherein the first self-sealing product includes:
between 20 and 70 parts by weight of a hydrocarbon resin per hundred parts of solid elastomer,
at most 20 parts by weight of a liquid plasticizer per hundred parts of solid elastomer, and
at most 60 parts by weight of a filler material per hundred parts of solid elastomer.

30. The pneumatic tyre according to claim 26, wherein the first self-sealing product includes:
between 20 and 70 parts by weight of a hydrocarbon resin per hundred parts of solid elastomer,
at most 20 parts by weight of a liquid plasticizer per hundred parts of solid elastomer, and
at most 60 parts by weight of a filler material per hundred parts of solid elastomer.

31. The pneumatic tyre according to claim 27, wherein the first self-sealing product includes:
between 20 and 70 parts by weight of a hydrocarbon resin per hundred parts of solid elastomer,
at most 20 parts by weight of a liquid plasticizer per hundred parts of solid elastomer, and
at most 60 parts by weight of a filler material per hundred parts of solid elastomer.

32. The pneumatic tyre according to claim 24, wherein the second self-sealing product includes:
between 30 and 90 parts by weight of a hydrocarbon resin per hundred parts of solid elastomer,
at most 60 parts by weight of a liquid plasticizer per hundred parts of solid elastomer, and
at most 30 parts by weight of a filler material per hundred parts of solid elastomer.

33. The pneumatic tyre according to claim 25, wherein the second self-sealing product includes:
between 30 and 90 parts by weight of a hydrocarbon resin per hundred parts of solid elastomer,
at most 60 parts by weight of a liquid plasticizer per hundred parts of solid elastomer, and
at most 30 parts by weight of a filler material per hundred parts of solid elastomer.

34. The pneumatic tyre according to claim 26, wherein the second self-sealing product includes:
between 30 and 90 parts by weight of a hydrocarbon resin per hundred parts of solid elastomer,
at most 60 parts by weight of a liquid plasticizer per hundred parts of solid elastomer, and
at most 30 parts by weight of a filler material per hundred parts of solid elastomer.

35. The pneumatic tyre according to claim 27, wherein the second self-sealing product includes:
between 30 and 90 parts by weight of a hydrocarbon resin per hundred parts of solid elastomer,
at most 60 parts by weight of a liquid plasticizer per hundred parts of solid elastomer, and
at most 30 parts by weight of a filler material per hundred parts of solid elastomer.

36. The pneumatic tyre according to claim 13,
wherein the creep resistance indicator is a Mooney viscosity measurement effected at 60° C. using an L-type rotor, and
wherein an amplitude by which the creep resistance indicator in the self-sealing layer varies is between 3 and 25 Mooney units (UM).

37. The pneumatic tyre according to claim 14,
wherein the creep resistance indicator is a Mooney viscosity measurement effected at 60° C. using an L-type rotor, and
wherein an amplitude by which the creep resistance indicator in the self-sealing layer varies is between 3 and 25 Mooney units (UM).

38. The pneumatic tyre according to claim 15,
wherein the creep resistance indicator is a Mooney viscosity measurement effected at 60° C. using an L-type rotor, and
wherein an amplitude by which the creep resistance indicator in the self-sealing layer varies is between 3 and 25 Mooney units (UM).

39. The pneumatic tyre according to claim 16,
wherein the creep resistance indicator is a Mooney viscosity measurement effected at 60° C. using an L-type rotor, and
wherein an amplitude by which the creep resistance indicator in the self-sealing layer varies is between 3 and 25 Mooney units (UM).

40. The pneumatic tyre according to claim 36, wherein the amplitude by which the creep resistance indicator in the self-sealing layer varies is between 5 and 20 Mooney units (UM).

41. The pneumatic tyre according to claim 37, wherein the amplitude by which the creep resistance indicator in the self-sealing layer varies is between 5 and 20 Mooney units (UM).

42. The pneumatic tyre according to claim 38, wherein the amplitude by which the creep resistance indicator in the self-sealing layer varies is between 5 and 20 Mooney units (UM).

43. The pneumatic tyre according to claim 39, wherein the amplitude by which the creep resistance indicator in the self-sealing layer varies is between 5 and 20 Mooney units (UM).

44. A method of manufacturing a green pneumatic tyre, comprising steps of:
applying a self-sealing layer, formed of at least one self-sealing product, to a surface of a tyre-building drum, the self-sealing layer having a creep resistance indicator that increases axially from a median plane towards outside of the pneumatic tyre; and
applying an internal sealing layer to contact with the self-sealing layer.
